(19) United States
(12) Patent Application Publication
(10) Pub. No.: US 2025/0035746 A1
(43) Pub. Date: Jan. 30, 2025

(54) PROCESS FOR EVALUATING A MEASUREMENT SIGNAL

(71) Applicant: Symeo GmbH, Neubiberg (DE)

(72) Inventors: Johanna Geiß, Erlangen (DE); Peter Gulden, Erding (DE); Erik Sippel, Nümberg (DE); Martin Vossiek, Fürth (DE)

(21) Appl. No.: 18/713,094

(22) PCT Filed: Oct. 27, 2022
(86) PCT No.: PCT/EP2022/080040

§ 371 Date: May 23, 2024

(30) Foreign Application Priority Data
Nov. 26, 2021 (DE) 10 2021 131 059.8

(51) Int. Cl. G01S 7/40; G01S 7/41; G01S 13/42; G01S 13/931

(52) U.S. Cl. CPC G01S 7/4052; G01S 7/415; G01S 13/931; G01S 13/42

(57) ABSTRACT

Method for evaluating measuring signals of a measuring system, for example a radar system, comprising at least one, for example, coherently operating, receiving device, wherein, after the identification of at least one target within a measuring image, artefact positions belonging to the target are determined within the measuring image.

### CLAIM OF PRIORITY

This application is a U.S. National Stage Application under 35 U.S.C. 371 from International Application No. PCT/EP2022/080040, filed Oct. 27, 2022, and published as WO 2023/094105 A1 on Jun. 1, 2023, which claims the benefit of priority to DE Application No. 102021131059.8, filed Nov. 26, 2021, the benefit of each of which are hereby incorporated by reference herein in their entirety, and each of which are hereby incorporated by reference herein in their entirety.

### TECHNICAL FIELD

The disclosure relates to a method for calibrating wave-based measuring systems, as well as a system and a device for carrying it out.

### BACKGROUND

A wave-based measuring system emits signals which are reflected at a target and then received again. The measurement is often carried out several times with a spatial offset, either by moving the measuring system or, in the case of a static measuring system, by transmitting or receiving at a different location or channel.

In the following, the wave-based measuring instrument is referred to as radar. The fact that the methods described can be carried out with all waveforms (e.g. electromagnetic, optical or acoustic) is generally recognised in the field. The measuring system is preferably designed to analyze the received signals coherently. The device for transmitting and receiving the signal is also referred to below as an antenna (as an example of such a device). However, the wave-based measuring instrument (measuring system) can, as is generally known in the art, be equipped with any device that enables the reception of the wave (e.g. antenna for electromagnetic waves; photodetectors or electro-optical mixers for optical waves, transducers or microphones for acoustic waves or transceivers).

### SUMMARY

Radars analyze received signals in order to obtain information about the distance and speed of a target on the one hand, and to determine the angle to a target on the other. To determine the angle antenna arrays are used, with which the received signal is scanned at different spatial positions. One or more spatial frequencies can be deduced from this scanned signal, which in turn provide information about the target position. To do this, the phase of the signal must be analysed depending on the antenna positions and offset against each other. Due to the manufacturing process, however, antenna arrays usually have non-idealities that also influence this phase, so that it is not possible to draw conclusions about the actual phases to be measured without further ado. A calibration must therefore be carried out.

Any parameters of the measuring system can be calibrated which cause the transmit or receive channels to have disturbed or non-ideal and generally different measurement characteristics, i.e. they are superimposed with a disturbance known as a channel error. Calibration is used to compensate for the calibration parameters or channel errors resulting from the calibration parameters.

Various methods for calibrating such measuring systems are known from the state of the art. For example, it is known to perform reference measurements on targets with a known position, while no other unconsidered targets or multipath effects are present in the measurement range. The resulting measuring signal can then be compared with a hypothetical ideal measuring signal and any deviation between the two can be minimised using the calibration parameters. The disadvantage of this method is that, due to external influences, temperature changes, ageing, etc., an initial calibration is not sufficient to ensure smooth operation. It is therefore necessary to regularly carry out a new calibration, preferably continuously while the sensor is in operation. However, as there is no controlled measuring environment for the initial calibration described above, such methods are unsuitable for calibration during operation, also known as online calibration.

Also known are methods in which the calibration parameters are estimated and the radar image is reconstructed (J. Geiss, E. Sippel, M. Hehn, and M. Vossiek, “Antenna Array Calibration Using a Sparse Scene”, IEEE Open J. Antennas Propag., vol. 2, pp. 349-361, 2021, doi: 10.1109/OJAP.2021.3061935). The basic assumption here is that only a fixed number of targets may occur within the radar image, and accordingly it is attempted to minimise error targets that occur by changing the calibration parameters. This also has the disadvantage that it must be known in advance how many real targets are in the measurement range, which again requires a controlled environment during calibration, which greatly complicates the ongoing operation of the sensors.

The present subject matter provides a method which makes it possible to calibrate the measuring system even if the measurement environment cannot be controlled or can only be controlled to a limited extent.

In particular, the present subject matter provides a method for evaluating measuring signals of a measuring system, preferably a radar system, comprising at least one, preferably coherently operating, receiving device, wherein artefact positions belonging to the target are determined within the measuring image after the identification of at least one target within a measuring image.

### BRIEF DESCRIPTION OF THE DRAWINGS

The invention is described below with reference to embodiment examples, which are explained in more detail with reference to the illustrations.

FIG. 1 a schematic view of a radar system in SAR mode, whereby the solid angle resulting at a position relative to the target as well as two further measurement positions are shown;

FIG. 2 an exemplary example of a measuring image as it appears with periodically occurring artefacts, whereby a target peak in the centre is surrounded by artefacts at regular intervals;

FIG. 3 a schematic vehicle which comprises a measuring system to be able to carry out a calibration according to implementation;

FIG. 4 a further example of a measuring image with a target and periodically occurring artefacts.

### DETAILED DESCRIPTION

Due to the geometry of the transmit and/or receive array, the artefact positions are deterministically dependent on the position of the target. This can be used to identify positions within a measuring image using any target at which artefacts are expected a priori in order to use these positions for calibration. It is not necessarily decisive whether there are other targets within the measuring image that were not or only partially recognised. The requirements for the environment are therefore minimal, namely only that a target can be identified. This simplifies calibration in uncontrollable environments, especially online calibration.

The term measuring image is preferably to be understood generally and refers to a spatial (usually two or three-dimensional) distribution of values, vectors and/or data that results directly or indirectly from one or more measurements of the receiving units. In a radar image or measuring image, position-dependent reconstruction results with amplitude and/or power and/or brightness values above a certain threshold value are detected and referred to as detection. Detections that can be assigned to a real existing and therefore correctly detected scatterer or transmitter are preferably referred to as targets. Furthermore, the identified target in the following can also mean a signal that has been declared as such and/or a signal that has been assumed to be “correct” for statistical considerations. For the method described below, it is only necessary to identify a signal as a “target”, regardless of whether it belongs to a real scatterer or transmitter or not. Peaks or detections that do not correspond to a real or assumed scatterer or transmitter (but are to be assigned to one or result from one) are referred to as artefacts.

In particular, a useful signal s_{Nutz} can be understood as the signal resulting from the measurement of a target, in contrast to an disturbance signal s_{stör} which is due to the artefacts.

The terms position, target position and artefact position can, in particular, optionally refer to a spatial frequency, an angle, a spatial position, a pixel and/or voxel, and/or the like, depending on the representation in which the radar imaging is performed.

Aa a channel error is designated in particular the error on a channel which is effectively effective on this channel. This can have a variety of causes, whereby the individual causes are described by calibration parameters. Many calibration parameters therefore cause a change in a common channel error. In most cases, the aim of a calibration is to determine the calibration parameters; however, any of the calibration procedures described can also be used to calibrate the channel errors. This can have advantages as the causes of a channel error described by calibration parameters do not need to be differentiated.

Preferably, the measuring system comprises at least one coherently operating receiving device and/or at least one coherently operating transmitting device. A coherently operating receiving device is preferably capable of detecting and/or establish a phase position, in particular a phase offset relative to at least one other receiving device and/or transmitting device and/or a reference phase. A coherently operating transmitting device is preferably capable of detecting and/or establishing a phase position, in particular a phase offset relative to at least one further receiving device and/or transmitting device and/or a reference phase.

For further explanation, two exemplary different embodiments of radars are considered below. Firstly, a single-input multiple-output (SIMO) radar with a single transmit antenna (TX) and N (N>1) receive antennas (RX) may be present. Alternatively, there could also be N (N>1) transmit antennas (TX) and a single receive antenna (RX). The cases can be assumed to be equivalent and are referred to as SIMO below for the sake of simplicity. Secondly, a MIMO radar with N (N>1) transmit antennas and N (N>1) receive antennas may be present.

In both cases, data recording can be done in such a way that the transmit antennas of a radar emit a signal s_t (t) or S_t (f). This can be scattered and/or reflected at the targets of an object scene or target scene and received by the RX antennas. Alternatively, it is also conceivable that a signal is emitted by an active object, e.g. a radio transmitter, and/or a radiating body (e.g. thermal radiation in the infrared or microwave range), i.e. no TX antenna is required at the measuring unit. In this case, however, it should be ensured that there is a fixed phase relationship between the transmitted signals for several measurements in succession.

As aperture, sometimes also referred to as the physical aperture, the spatial range in which the radar scans the wave field—i.e. the extent of the physically present antennas—is designated. As virtual aperture, in particular, the effectively scanned aperture when using a MIMO array is designated The virtual array or the virtual antenna positions are the effectively resulting scanning positions from the convolution of the RX array with the TX array. In particular, as synthetic aperture the effectively achieved total aperture is designated, which results from several coherently analysed measurements in which the radar is arranged at different relative spatial positions (measurement principle of the “synthetic aperture radar”—SAR).

According to a first embodiment, a characteristic of the measuring signal, such as the amplitude, a power value or a change in these characteristics can be determined at the specific artefact positions. It is also possible to determine several of these characteristics and/or changes, for example several amplitudes in the vicinity of and/or at an expected artefact position, as well as a power value at the artefact position, etc. The advantage of obtaining these characteristics directly from an artefact position or its surroundings is that they can be used directly for a calibration.

In another embodiment, the characteristics can also be used to derive a quality criterion for one or more of the measurements. It is also possible to classify one or more underlying calibration parameters or channel errors. This has the advantage that a simple and direct assessment of the measurement(s) can be made without the necessity for checking the measurement environment. In addition, the knowledge of the probable position of artefacts can also be used to exclude certain parts of the measuring image from consideration. This has the advantage that, in cases in which one is only interested in a section of the measuring image, it may not be necessary to carry out a complex calibration at all, as no artefacts are expected there anyway.

In a further embodiment, ratios can also be formed and/or evaluated from the characteristics of targets or artefacts and their change can be determined in dependence of at least one calibration parameter and/or channel error. For example, the amplitude and/or power value at an expected artefact position could be divided by the amplitude or power value at the target position. From this ratio, the relative size of the artefacts can be easily determined, for example. The same can also be done for data that are first formed from the measuring images, such as mean values over certain areas or similar. These characteristics or the ratios can subsequently be compared with those resulting from the measuring signal in conjunction with a calibration parameter. The advantage of this is that the influence of the calibration can be determined immediately and the calibration can be adjusted accordingly.

Preferably, in this way, an online calibration (i.e. during operation) of the measuring system can be carried out in which at least one characteristic (such as an amplitude, a power value, etc.) or a ratio at at least one of the previously determined artefact positions is used to adjust one or more channel errors.

For example, one or more channel errors can be adjusted in such a way that the artefact size or, in other words, the error influence of the measurement is changed, preferably optimised, further preferably minimised. Among other things, this is done by attempting to optimise the calibration parameters so that the artefacts s_{stör} caused by them (e.g. described by the amplitude or power of the artefacts) are minimised, while the useful signal s_{Nutz} is maximised.

For the calibration, an error function ƒ(s_{Stör}) that depends on the artefacts is then minimised, while another function g(s_{Nutz}) that depends on the useful signal/target is maximised. The calibration would then correspond to the solution of e.g.

$${min}_{γ} f ( {s}_{Stör} ) - μ g ( {s}_{Nutz} )$$

Whereby in γ the parameters to be calibrated are summarised. With each change of γ, the radar image must be reconstructed at least at the artefact positions in order to determine the updated values of ƒ(s_{Stör}) and g(s_{Nutz}). Alternatively or additionally, comparable formulations can be optimised, such as

$${min}_{γ} f ( {s}_{Stör} ) + μ \frac{1}{g ( {s}_{Nutz} )} ,$$

and/or the function derived from the useful signal is kept constant, e.g. via

$${min}_{γ} f ( {s}_{Stör} ) subject to g ( {s}_{Nutz} ) = const . ,$$

and/or it is prevented that the function derived from the useful signal falls below a certain value ε, e.g. via

$${min}_{γ} f ( {s}_{Stör} ) subject to g ( {s}_{Nutz} ) \geq ε .$$

The value ε can, for example, be selected based on the useful power P_{Nutz} available at the start of calibration.

It is common to all variants that the error function derived from the artefacts is minimised, while the trivial solution, in which any signal (including useful signal) simply disappears, is prevented.

Instead of minimising the function ƒ(s_{Stör}), other optimisation is also possible, especially if this is based on previously identified artefact positions. For example, the parameters γ can simply be set so that the above function combinations fall below a defined threshold instead of searching for the global minimum.

In a further embodiment example, it is possible to define a useful power P_{Nutz} as g(s_{Nutz}) as well as to derive an disturbance power P_{Stör} based on the artefacts as ƒ(s_{Stör}). In addition to the variants described above, it would then also be possible to define a signal-to-disturbance ratio (SDR) via

$$SDR = \frac{{P}_{Nutz}}{{P}_{St \ddot{o} r}} .$$

As an implementation variant, the solution of

$${max}_{γ} SDR ,$$

could be sought for calibration.

The advantage of this over conventional calibrations, in which the error power is usually minimised over the entire angular range, is that specifically only the occurring and expected artefacts are minimised. The artefact positions result in particular from the measurement arrangement, which leads to periodic channel error influences and thus causes the error power to concentrate at the specific positions and generate artefacts instead of being distributed over the entire angular range.

This is particularly advantageous when the calibration is done in operation (online calibration). If a single target is identified as the correct target in conventional calibrations and the power is minimised in the entire remaining angular range, in particular no other (correct) target may be present at this distance. With the targeted minimisation of artefacts at the known artefact positions, on the other hand, any other correct targets at other positions do not affect the calibration. Only in the event that another correct target corresponds exactly to an artefact position and is not recognised as a correct target, the calibration may not be performed correctly.

In a further embodiment, the measuring system has at least one transmitting device, as part of the receiving device and/or separately.

In one embodiment, the present subject matter can derive the determination of an artefact position from the position, or spatial frequency, of a known target. For that, the geometric properties of the measuring system are used to determine a clear relationship between the spatial frequency of a target and the spatial frequencies of the associated artefacts.

If, according to a further embodiment, there is a fixed or periodic relationship between the target and the associated artefacts, which is used to infer an artefact position. In this case, the effort required for calibration is minimal, as not every artefact position has to be derived individually, but an entire set of artefact positions is already known for a target. A set refers in particular to a number of artefact positions that are completely determined by a finite number of integer index parameters as a function of the target position and properties of the measuring system.

A further embodiment may therefore be to perform a calibration, wherein the measuring signal is formed by measurements with a periodic structure and/or periodic elements, in particular by displacing the receiving device and/or transmitting device, preferably at regular intervals according to the SAR principle, and/or by displacing at least one target relative to the receiving device and/or transmitting device at regular intervals, preferably according to the inverse SAR principle, and/or by using several receiving devices and/or several transmitting devices, preferably according to the MIMO principle.

By the calibration parameters to be calibrated in a transmit or receive array can change the expected signal can be changed slightly on each channel, resulting in a channel error per channel that is dependent on the calibration parameters. If the measurement is now carried out several times with a uniform spatial offset, the same channel errors can occur again and a deterministic channel error structure can result within the overall measurement. In many cases, this channel error structure is periodic, as the displacement of the receiver array and/or the target scene occurs at regular intervals. Generally, a multiple measurement is created either by a uniform movement of the radar and/or within a single measurement if the radar operates according to the multiple-input multiple-output (MIMO) principle. In this case, the virtual total array can result from the convolution of the transmit and receive arrays. This also results in a periodic channel error structure.

This is the case, for example, when the measuring system is used in SAR mode. Since, as described above, periodically occurring artefact positions are known in this case. In particular, the properties of the measuring system in this case are given by the displacement distance Lₛₐᵣ and the wavelength used λ_{c}. As already mentioned at the beginning, the set of artefact positions in dependence of the index parameter is determined by the formula

$${θ}_{n} = arcsin ( sin {θ}_{0} + n \frac{{λ}_{c}}{2 {L}_{sar}} ) .$$

Identical or similar dependencies can also be determined when using a radar according to the inverse SAR principle or the MIMO principle and can be used in accordance with the implementation.

It is further preferred if use several targets are used at different angles λ_{c} to perform the calibration. On the one hand, a maximisation of the information collected is achieved. On the other hand, the influences of angle-dependent calibration parameters (coupling and phase centres, αₙ_{ᵣ}^{k,pz}(k₀)) and angle-independent calibration parameters (phase and amplitudes, αₙ_{ᵣ}^{p,a}) on the channel errors and thus on the artefacts can be differentiated. The adjustment of the former should cause an angle-dependent change in the channel errors and artefacts, while the change of the latter at different angles θ₀ causes a uniform change in the channel errors and artefacts. Nevertheless, a calibration is also possible with only a single target.

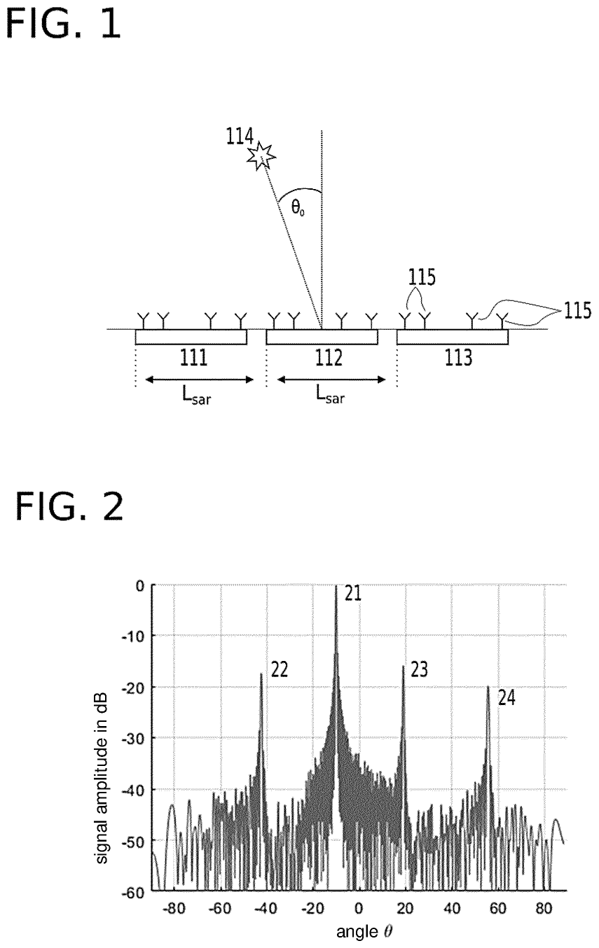

In particular, in a further embodiment, it is also possible to select from a series of measurements those in which a periodic structure is present. For example, those in which the measurement position of the measuring system was an integer multiple of Lₛₐᵣ (see FIG. 1).

According to embodiment, it is also possible to combine measuring signals from several measurements. A combination in the above sense can be, for example, to consider the average and/or the superposition of the different measuring signals resulting from the measuring images of several different measurements. For example, the amplitudes from several different measuring images can be added or averaged point by point to obtain a combined measuring image, which is then used to perform a calibration in the above sense. It is also possible, for example, to select and combine from a large number of measurements those in which the measuring system according to the SAR principle each time was at the same measuring position or at different measuring positions.

Thus several measurements, e.g. at least four or at least ten or at least one hundred, can be used for the calibration. This increases the available information and at the same time allows the calibration parameters to be changed only slowly. In principle, however, only a single measurement is required for calibration, so that such a combination is possible but not necessary.

With the above procedure, a comparatively large number of calibration parameters, Y, may need to be available for optimisation. The present subject can include making a pre-estimation using the measurement data before the actual calibration in order to approximate the calibration parameters. This pre-estimation can be carried out in combination with already known methods, or also exclusively using known methods, such as a calibration of the antenna measurement chamber by the manufacturer.

The method according to the present subject matter can provide measuring systems which, in addition to a receiving device (RX), also have a transmitting device (TX), such as a transmitting antenna. Alternatively, a receiving device itself may also be able to function as a transmitting device (transceiver). In many cases, several such receiving and/or transmitting devices are realised in the measuring system. In these cases, the method according to the present subject matter can be used, whereby of at least one receiving device (RX) and/or transmitting device (TX)
a. a phase position, in particular a phase offset relative to at least one further receiving device (RX) and/or transmitting device (TX) and/or a reference phase, and/or
b. an attenuation and/or amplification relative to at least one further receiving device (RX) and/or transmitting device (TX) and/or a reference amplitude, and/or
c. a coupling influence due to a further receiving device (RX) and/or transmitting device (TX), for example a coupling matrix, and/or
d. a parameter describing a complex relative amplitude between the receiving device (RX) and/or transmitting device (TX) and a further receiving device (RX) and/or transmitting device (TX), and/or
e. a parameter which describes the time offset to at least one receiving device (RX) and/or transmitting device (TX),
   is or are calibrated and/or it is identified whether this leads to channel errors.

In particular, under a coupling matrix is to be understood here a matrix whose component Mᵢⱼ represents the coupling between the i-th and the j-th transmitting or receiving device (e.g. antenna), where i, j∈{1, . . . , Z} and Z is the number of transmitting or receiving devices of the measuring system. Optionally, the coupling matrix M is a square, possibly symmetrical matrix of size Z×Z.

The above object is furthermore solved in particular by a wave-based measuring system, preferably a radar measuring system, for carrying out the method according to the above embodiments. Further features result from the preceding and following explanations. In particular, an evaluation unit of the measuring system can be configured to carry out the above and/or subsequent method steps.

The method according to the present subject matter can include embodiments suitable for online calibration in which a measuring system of a vehicle, in particular motor vehicle, preferably passenger car and/or lorry, is configured to carry out the method according to the invention.

It is often particularly difficult to keep the measurement environment under control in vehicles, since a plurality of targets (pedestrians, other cars, etc.) can move in the vicinity of the vehicle during operation.

The vehicle can be designed as a: Motor vehicle, watercraft, aeroplane, crane or rail vehicle.

Firstly, the ideal received signal at the nᵣ-th RX antenna of a SIMO or MIMO radar is to be considered, whereby the radar is located at the position x_{R} during the measurement, this position being on the same axis as the aperture. For the sake of simplicity, it is assumed that this position corresponds to the position of the TX antenna. The RX antenna is located at a distance lₙ_{ᵣ} from the TX antenna, i.e. at x_{R}+lₙ_{ᵣ}. The ideal received signal in the frequency range can then be expressed as

$${S}_{{n}_{r} ideal} ( f ) = {H}_{{n}_{r}} ( {x}_{R} ) {H}_{z} {H}_{t} ( {x}_{R} , ) {S}_{t} ( f ) ,$$

with the transfer function from the TX antenna to the target

$${H}_{t} ( {x}_{R} , ) = {e}^{j {k}_{0} {x}_{R}} ,$$

the transfer function from the target to the RX antenna

$${H}_{{n}_{r}} ( {x}_{R} ) = {e}^{j {k}_{0} ( {x}_{R} + {l}_{{n}_{r}} )} ,$$

and the transfer function for the target reflection, including the path attenuation

$${H}_{z} = {A}_{0} {e}^{j {ϕ}_{0}} .$$

Due to the incident wave from a target thus a spatial distribution of the wave front along the aperture is created, which is scanned by the radar at the antenna positions. Hereby corresponds

$${k}_{0} = \frac{2 π}{{λ}_{c}} sin {θ}_{0}$$

with the wavelength

$${λ}_{c} = \frac{{c}_{0}}{{f}_{c}}$$

and speed of light c₀, to the spatial angular frequency k₀ over the aperture, which results from the angle-dependent run time difference along the physical aperture. The terms target angle θ₀ and spatial frequency k₀ are used interchangeably, as they can be converted directly into each other. A₀ and ϕ₀ are the received amplitude and phase specific to the measurement for this target. The signal can then be transformed to

$${S}_{{n}_{r} ideal} ( {f}_{c} ) = {A}_{0} {e}^{j {ϕ}_{0}} {e}^{j 2 {k}_{0} ( {x}_{R} + \frac{{l}_{{n}_{r}}}{2} )} {S}_{t} ( {f}_{c} ) .$$

Non-idealities now occur at the individual antennas or channels. These include, for example, amplitude and/or phase errors, coupling between the channels and position errors of the antenna phase centres. The values that describe these non-idealities are referred to as calibration parameters γ. All these errors can in turn be summarised as a channel-specific transfer function Hₙ_{ᵣ}_{,error}(γ), so that the following applies to the erroneous signal

$${S}_{{n}_{r}} ( {f}_{c} ) = {H}_{{n}_{r} error} ( γ ) {S}_{{n}_{r} ideal} ( {f}_{c} ) .$$

This transfer function is determined by the type of calibration parameter that occurs and the calibration parameter value. For a constant (and assumed known) target angle θ₀ or a constant spatial frequency k₀, the calibration parameters are reduced to a channel error specific to this channel αₙ_{ᵣ}(k₀). This in turn is made up of two partial factors, so that

$${a}_{{n}_{r}} ( {k}_{0} ) = {a}_{{n}_{r}}^{p , a} {α}_{{n}_{r}}^{k , pz} ( {k}_{0} ) .$$

The first partial factor αₙ_{ᵣ}^{p,a} is caused by calibration parameters such as phase and amplitude errors and is independent of the actual measurement. The second partial factor any αₙ_{ᵣ}^{k,pz}(k₀) is caused by calibration parameters such as coupling and/or phase centre error and may depend on the spatial frequency k₀ generated by the target or therefore (directly) on the target angle θ₀.

The measurement is now carried out with all the antennas in the array, with each antenna having its own channel factor. To increase the aperture, the SIMO radar is now extended to a MIMO radar or a SAR. In the latter case, a synthetic aperture is generated by shifting the entire radar in equal steps Lₛₐᵣ, see FIG. 1.

If one now views the overall measurement as a continuous scanning process, the individual scanning points are scanned in periodic succession by the different antennas. As the scanned values are multiplied by the current channel error of the active antenna, the channel terms πₙ_{ᵣ}(k₀) appear in periodic succession over the overall signal. This corresponds to a multiplication of an ideal received signal (in the spatial range) over the aperture with a periodic error signal. In the spatial frequency range, this corresponds to the convolution of the ideal measuring signal with the periodic signal, which is why the spectrum of the ideal measuring signal is periodically repeated in the overall spectrum. These repetitions, referred to below as artefacts, occur at the spatial angular frequencies

$${k}_{n} = 2 {k}_{0} + n \frac{2 π}{{L}_{sar}} ,$$

or at the angles

$${θ}_{n} = arcsin ( sin {θ}_{0} + n \frac{{λ}_{c}}{2 {L}_{sar}} ) .$$

It should be noted that the artefacts are only periodic in the spatial frequency range of the signal, which results, for example, from the Fourier transformation. Due to the distortion of the conversion of the spatial frequency into an angle, the artefacts are no longer necessarily periodic, but still occur at deterministic artefact positions. In the same way, the deterministic artefact positions can be calculated in a 2D or 3D reconstruction and thus artefacts can be identified. Ultimately, it is not necessarily decisive whether the artefacts occur periodically or not. What is decisive is that they occur at deterministic artefact positions.

FIG. 1 shows a schematic representation of a radar in SAR mode. The target 114 is located in the solid angle θ₀ in front of the measuring system consisting of transmit/receive equipment 115, which is located at position 112. The other measurement positions 111, 113 are each displaced by the distance Lₛₐᵣ. The regular displacement results in a periodic occurrence of artefacts.

FIG. 2 shows a typical measuring image, which shows the measurement amplitude as a function of the angle. The peak in the centre is the signal of the target 21, while artefacts 22, 23, 24 are visible at periodically occurring positions (here approximately every 20 degrees). If a calibration is carried out using the present subject matter, then by the known artefact positions it can immediately be begun to influence the height of the artefact peaks by means of the calibration parameters.

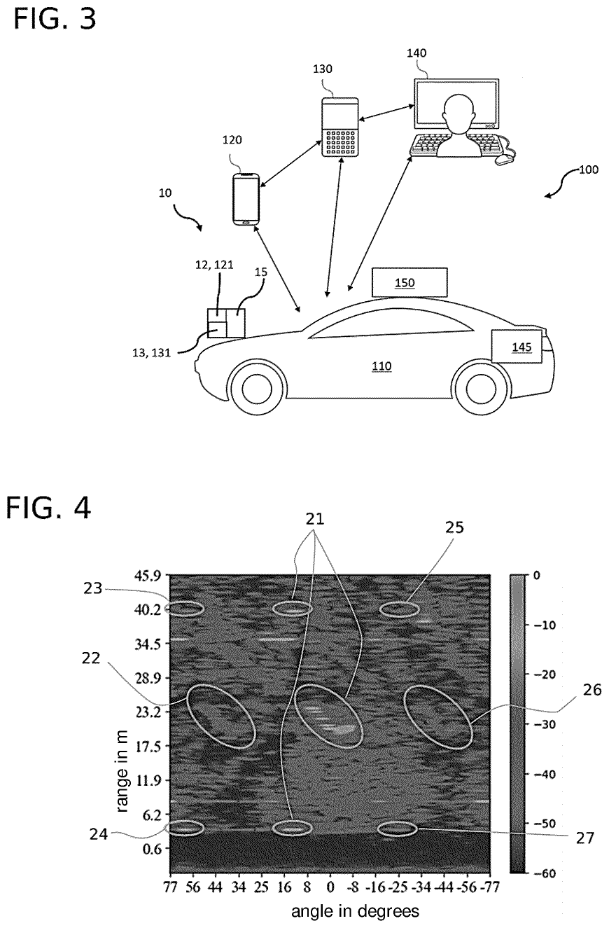

FIG. 3 shows a system 100 comprising an autonomous vehicle 110 and a radar measuring system (radar system) 10 according to embodiments. The radar measuring system 10 comprises at least one first radar module 12 with at least one first radar antenna 121 (to transmit and/or receive corresponding radar signals), and at least one second radar module 13 with at least one second radar antenna 131 (to transmit and/or receive corresponding radar signals) as well as an evaluation unit 15.

The system 100 may comprise a passenger input device and/or output device 120 (passenger interface), a vehicle coordinator 130 and/or an external input and/or output device 140 (remote expert interface; for example for a control centre). In embodiments, the external input and/or output device 140 may allow an external (to the vehicle) person and/or entity to make and/or modify settings on or in the autonomous vehicle 110. This external person/entity may be different from the vehicle coordinator 130. The vehicle coordinator 130 may be a server.

The system 100 enables the autonomous vehicle 110 to modify and/or adjust a driving behaviour dependent on parameters, which are by a vehicle passenger (for example, by means of the passenger input device and/or output device 120) and/or other persons and/or entities (for example, via the vehicle coordinator 130 and/or the external input and/or output device 140). The driving behaviour of an autonomous vehicle may be predetermined or modified by (explicit) input or feedback (for example by a passenger specifying a maximum speed or a relative comfort level), by implicit input or feedback (for example a pulse of a passenger), and/or by other suitable data and/or communication methods for a driving behaviour or preferences.

The autonomous vehicle 110 is preferably a fully autonomous motor vehicle (e.g. car and/or lorry), but may alternatively or additionally be a semi-autonomous or (other) fully autonomous vehicle, for example a watercraft (boat and/or ship), a (particularly unmanned) aerial vehicle (aeroplane and/or helicopter), a driverless motor vehicle (e.g. car and/or lorry) et cetera. Additionally or alternatively, the autonomous vehicle may be configured in such a way that it may switch between a semi-autonomous state and a fully-autonomous state, wherein the autonomous vehicle may have characteristics that can be associated with both a semi-autonomous vehicle as well as a fully-autonomous vehicle (depending on the state of the vehicle).

The autonomous vehicle 110 preferably comprises an on-board computer 145.

The evaluation unit 15 may be arranged at least partially in and/or on the vehicle 110, in particular (at least partially) integrated into the on-board computer 145, and/or (at least partially) integrated into a calculation unit in addition to the on-board computer 145. Alternatively or additionally, the evaluation unit 15 may be (at least partially) integrated into the first and/or second radar module 12, 13. If the evaluation unit 15 is (at least partially) provided in addition to the on-board computer 145, the evaluation unit 15 can be in communication with the on-board computer 145 so that data can be transmitted from the evaluation unit 15 to the on-board computer 145 and/or vice versa.

Additionally or alternatively, the evaluation unit 15 may be (at least partially) integrated into the passenger input device and/or output device 120, the vehicle coordinator 130, and/or the external input and/or output device 140. In particular in such a case, the radar measuring system may comprise a passenger input device and/or output device 120, a vehicle coordinator 130 and/or an external input and/or output device 140.

In addition to the radar modules 12, 13, the autonomous vehicle 110 may include at least one further sensor device 150, (for example, at least one computer vision system, at least one LIDAR, at least one speed sensor, at least one GPS, at least one camera, etc.).

The on-board computer 145 may be configured to control the autonomous vehicle 110. The on-board computer 145 may further process data from the at least one sensor device 150 and/or at least one other sensor, in particular a sensor provided or formed by at least one radar module 12, 13, and/or data from the evaluation unit 15 to determine the status of the autonomous vehicle 110.

Based on the status of the vehicle and/or programmed instructions, the on-board computer 145 can preferably modify or control the driving behaviour of the autonomous vehicle 110. The evaluation unit 13 and/or the on-board computer 145 is (are) preferably a (general) computation unit adapted for I/O communication with a vehicle control system and at least one sensor system, but may additionally or alternatively be formed by any suitable computation unit (computer). The on-board computer 145 and/or the evaluation unit 15 may be connected to the Internet via wireless connection. Alternatively or additionally, the on-board computer 145 and/or the evaluation unit 15 may be connected to any number of wireless or wired communication systems.

For example, any number of electrical circuits, in particular as part of the evaluation unit 15 and/or the on-board computer 145, the passenger input device and/or output device 120, the vehicle coordinator 130 and/or the external input and/or output device 140 may be implemented on a circuit board of a corresponding electronic device. The circuit board may be a general circuit board, which may comprise various components of an (internal) electronic system, an electronic device and connections for other (peripheral) devices. Specifically, the circuit board may have electrical connections through which other components of the system can communicate electrically (electronically). Any suitable processors (for example, digital signal processors, microprocessors, supporting chipsets, computer readable (non-volatile) memory elements, etc.) may be coupled to the board (depending on corresponding processing requirements, computer designs, etc.). Other components, such as an external memory, additional sensors, controllers for audio-video playback and peripheral devices may be connected to the board, such as plug-in cards, via cables, or integrated into the board itself.

In various embodiments, functionalities described herein may be implemented in emulated form (as software or firmware), with one or more configurable (e.g. programmable) elements arranged in a structure that enables this functionality. The software or firmware providing the emulation may be provided on a (non-volatile) computer-readable storage medium, comprising instructions that allow one or more processors to perform the corresponding function (the corresponding method).

The above description of the illustrated embodiments does not purport to be exhaustive or limiting as to the exact embodiments as described. While specific implementations of and examples of various embodiments or concepts have been described herein for illustrative purposes, deviating (equivalent) modifications are possible, as will be apparent to those skilled in the present field. These modifications may be made taking into account the above detailed description or the figures.

Different embodiments may include any suitable combination of the embodiments described above, including alternative embodiments of embodiments described above in conjunctive form (e.g., the corresponding “and” may be an “and/or”).

In addition, some embodiments may include one or more articles (e.g., in particular, non-volatile computer-readable media) having instructions stored thereon that, when executed, result in an action (a method) according to one of the embodiments described above. In addition, some embodiments may include devices or systems having any suitable means for performing the various operations of the embodiments described above.

In certain contexts, the embodiments discussed herein may be applicable to automotive systems, in particular autonomous vehicles (preferably autonomous automobiles), (safety-critical) industrial applications, and/or industrial process control systems.

In addition, parts of the described radar system or the described radar measuring system (or in general: wave-based measuring system) may comprise electronic circuitry to perform the functions and methods described herein. In some cases, one or more parts of the respective system may be provided by a processor that is specifically configured to perform the functions as well as method steps described herein. For example, the processor may include one or more application-specific components, or may include programmable logic gates which are configured in such a way that they perform the functions described herein.

At this point, it should be noted that all of the parts or functions described above can be viewed in isolation and in any combination, in particular the details shown in the drawings. Modifications thereof are familiar to the skilled person.

Furthermore, it is pointed out that a scope of protection as broad as possible is sought. In this respect, the disclosure contained in the claims can also be specified by features that are described with further features (even without these further features necessarily being included). It is explicitly pointed out that round brackets and the term “in particular” are intended to emphasise the optionality of features in the respective context (which does not mean, conversely, that a feature is to be regarded as mandatory in the corresponding context without such identification).

1. A method for evaluating measuring signals of a radar system, the method comprising:
identifying at least one target within a measuring image; and
determining artefact positions associated with the identified at least one target within the measuring image.

2. The method of claim 1, further comprising determining at least one characteristic of the measuring signal at the determined artefact positions, wherein the characteristic includes at least one of an amplitude, a power value, or a change in one or more of these characteristics.

3. The method of claim 2, wherein the amplitude or the power value corresponding to at least one artefact is used to:
derive a quality criterion for a calibration or a measurement; or
classify one or more underlying calibration parameters or channel errors.

4. The method of claim 2, in which the, further comprising:
forming characteristics or ratios thereof of targets or artefacts from at least one measuring signal or from data derived from at least one measuring signal; and
comparing the formed characteristics or ratios with those of targets or artefacts formed from the respective measuring signal or data derived therefrom and at least one calibration parameter.

5. The method of claim 4, wherein at least one characteristic or ratio at at least one expected artefact position is evaluated, and its change is considered in dependence of at least one calibration parameter or channel error.

6. The method of claim 2, wherein at least one characteristic at at least one artefact position is used to perform a calibration of the radar system.

7. The method of claim 4, wherein at least one calibration parameter or channel error is adjusted to change an error influence on the measurement, wherein the change is optimized to minimize the error influence.

8. The method of claim 1, wherein the radar system includes at least one transmitting device as a component of a receiving device or separately.

9. The method of claim 1, wherein at least one artefact position to be evaluated is determined from a position or a spatial frequency of a known target.

10. The method of claim 1, wherein at least one further artefact position is inferred from an artefact position or a target position by means of a fixed relationship.

11. The method of claim 1, wherein the measuring signal is formed by measurements with a periodic structure or periodic elements, including displacement of a receiving device or transmitting device at regular intervals according to an SAR principle, or displacement of at least one target relative to the receiving device or transmitting device at regular intervals, preferably according to an inverse SAR principle, or using several receiving devices or several transmitting devices according to a MIMO principle.

12. The method of claim 10, in which, wherein from a series of measurements, those having a corresponding periodic structure are selected for the method.

13. The method of claim 1, wherein measuring signals from several measurements are combined.

14. The method of claim 1, wherein a calibration includes a preceding step of at least roughly predetermining or pre-estimating at least one calibration parameter.

15. A method for operating a radar system, comprising:
identifying at least one target within a measuring image;
determining artefact positions associated with the identified target within the measuring image; and
calibrating or identifying whether calibration leads to channel error in at least one receiving device or a transmitting device used for an acquisition to generate the measuring image.

16. The method of claim 15, wherein the identifying whether calibration leads to channel errors includes identifying whether the error comprises:
a phase position relative to at least one further receiving device or transmitting device or a reference phase;
an attenuation or amplification relative to at least one further receiving device or transmitting device or a reference amplitude;
a coupling influence due to a further receiving device or transmitting device;
a parameter describing a complex relative amplitude between the receiving device or transmitting device and a further receiving device or transmitting device; or
a parameter describing a time offset to at least one receiving device or transmitting device.

17. A radar-based measuring system, comprising:
a receiving device configured to acquire data to generate a measuring image;
a processor circuit;
a memory circuit communicatively coupled with the processor circuit, the memory circuit comprising instructions that, when executed by the processor circuit, cause the radar-based measuring system to:
identify at least one target within a measuring image; and
determine artefact positions associated with the identified target within the measuring image.

18. The radar-based measuring system of claim 17, wherein the instructions comprise instructions to determine at least one artefact position from a position or a spatial frequency of a known target.

19. The radar-based measuring system of claim 17, wherein at least one further artefact position is inferred from an artefact position or a target position by means of a fixed relationship.

20. The radar-based measuring system of claim 17, wherein the receiving device, the processor circuit, and the memory circuit are coupled to a vehicle or comprise a portion of a vehicle.
